(19) United States
(12) Patent Application Publication
(10) Pub. No.: US 2020/0298827 A1
(43) Pub. Date: Sep. 24, 2020

(54) LOW VOLTAGE HYBRID SYSTEM FOR A HEAVY DUTY VEHICLE

(71) Applicant: AVID TECHNOLOGY LIMITED, CRAMLINGTON (GB)

(72) Inventor: RYAN MAUGHAN, STOCKSFIELD (GB)

(21) Appl. No.: 16/639,717

(22) PCT Filed: Aug. 16, 2018
(86) PCT No.: PCT/GB2018/052328

§ 371 Date: Feb. 17, 2020

(30) Foreign Application Priority Data
Aug. 16, 2017 (GB) 1713165.7

(51) Int. Cl. B60W 20/15; B60K 6/28; B60K 6/26; B60L 1/00; B62D 5/04; B60L 58/12; B60K 11/06; B60R 16/03; B60R 16/033; B60T 8/17

(52) U.S. Cl. CPC B60W 20/15; B60Y 2200/143; B60K 6/26; B60L 1/003; B62D 5/046; B60L 58/12; B60K 11/06; B60R 16/0307; B60R 16/033; B60T 8/1701; B60K 2006/268; B60L 2200/40; B60Y 2200/92; B60Y 2400/81; B60Y 2200/142; B60K 6/28

(57) ABSTRACT

A hybrid system for a heavy duty vehicle having an engine and a pneumatic system. The hybrid system comprises a direct current (dc) network having a peak voltage not exceeding 60 volts, and connected to the dc network electrical components including: a battery, a starter/generator electric machine having a power delivery mode in which an electrical energy input to the starter/generator is converted into a rotational power output and an electricity generation mode in which a rotational power input is converted into an electrical power output, a plurality of electrically powered ancillary devices one of which is an electrically powered compressor of the pneumatic system, a plurality of vehicle parameter sensors, a communications network and a controller, wherein the controller, the vehicle parameter sensors and the electrical components are connected to the communications network; and wherein the controller is configured to control the flow of electricity between the starter/generator, the battery, and the electricity consuming devices according to pre-programmed priorities and wherein the priorities include causing kinetic energy converted into electrical energy by the starter/generator when in its electricity generation mode to be stored by the battery by charging the same or in the pneumatic system by operating an electric motor driven air compressor of the pneumatic system.

### FIELD OF THE INVENTION

The invention relates to low voltage hybrid systems and in particular such systems for a heavy duty vehicle, such as a truck or a bus.

### BACKGROUND OF THE INVENTION

Heavy duty vehicles such a trucks and buses are powered typically by internal combustion engines. Hybrid systems, which in the context of this specification means the partial electrification of a vehicle having an internal combustion engine, have been widely adopted in passenger cars. The common approach in passenger cars is to base electrification around a 48 volt system. 48 volt systems have been demonstrated on heavy duty vehicles, but with limited success owing to the small amount of electrical power available for propulsion when compared to the power available from the vehicle's internal combustion engine.

The proportion of propulsion power available as electrical power may be increased by operating at a higher voltage. High voltage hybrid systems typically operate at 300 to 600 volts. However, at high voltages IGBT's are required, whereas at an operating voltage of 48 volts MOSFET's may be used, which are considerably less expensive than IGBT's.

In a heavy duty vehicle the parasitic load placed on the power source, which historically has been an internal combustion engine alone, is much greater than on a car. Typically, a heavy duty vehicle will have an air compressor, a power steering pump, an air-conditioning unit, lubrication pumps, coolant pumps and associated fans. Together these ancillary items may place a load of 30 to 40 kW on an internal combustion engine rated at 150-200 kW.

It has been found that by focusing on powering ancillary devices electrically a hybrid system that makes a significant overall contribution to a heavy duty vehicle's power requirements may be implemented.

The low voltage hybrid system of the present invention would typically operate at a nominal voltage of 48 volts with a peak voltage for safety reasons of not greater than 60 volts. The hybrid system of the invention also allows certain ancillary components to be down sized, thereby reducing the power requirement of the down sized devices and the unladen weight of such a hybrid vehicle.

### SUMMARY OF THE INVENTION

According to the invention there is provided a hybrid system for a heavy duty vehicle having an engine and a pneumatic system, the hybrid system comprising a direct current (dc) network having a peak voltage not exceeding 60 volts, and connected to the dc network electrical components including: a battery, a starter/generator electric machine having a power delivery mode in which an electrical energy input to the starter/generator is converted into a rotational power output and an electricity generation mode in which a rotational power input is converted into an electrical power output, a plurality of electrically powered ancillary devices one of which is an electrically powered compressor of the pneumatic system, a plurality of vehicle parameter sensors, a communications network and a controller, wherein the controller, the vehicle parameter sensors and the electrical components are connected to the communications network; and wherein the controller is configured to control the flow of electricity between the starter/generator, the battery, and the electricity consuming devices according to pre-programmed priorities and wherein the priorities include causing kinetic energy converted into electrical energy by the starter/generator when in its electricity generation mode to be stored by the battery by charging the same or in the pneumatic system by operating an electric motor driven air compressor of the pneumatic system.

Advantageously, the pneumatic system comprises an air compressor and a compressed air tank and wherein the air compressor is powered by an electric motor and wherein the pneumatic system has an optimum air tank pressure.

The pneumatic system may include pneumatically operated brakes.

Preferably, during coasting and/or braking of a heavy duty vehicle equipped with the hybrid system, the common controller switches the starter/generator electric machine to its electricity generation mode and controls the flow of electricity to the battery, the electric motor of the air compressor and/or electricity consuming devices according to pre-programmed priorities.

The air tank may be specified such that it may be pressurised to a second pressure greater than the optimum air tank pressure, wherein the air tank is provided with a pressure sensor and the algorithm prioritises pressurising the air tank to the optimum pressure, or where the vehicle is coasting or braking and the battery is fully charged operating the compressor to pressurise the air tank up to the second pressure.

It is preferred that under braking the generator subjects the engine to a load and that load is proportional to the braking effort.

Advantageously, the controller switches the starter/generator out of generation mode when the vehicle accelerates.

The electricity consuming devices may include a power steering motor, and wherein the controller controls the speed of the power steering motor according to the speed of the vehicle, reducing the power steering motor speed with increasing vehicle speed.

Preferably, the controller causes the starter/generator to charge the battery when the battery charge level is below a threshold charge level required to operate the power steering motor.

The plurality of electricity consuming devices may include one or more inverter driven devices.

The engine may include a power take off shaft and wherein the stater/generator electric machine is driven by the power take off shaft.

The power take off shaft may be coupled to the starter/generator electric machine by one of: a direct coupling, a gear set, a belt drive and a chain drive.

The starter/generator may be located between the engine and the transmission of the vehicle.

Preferably, the electricity consuming devices include at least one cooling fan motor and wherein the algorithm priorities operation of the at least one cooling fan motor according to the cooling requirements of the vehicle.

### BRIEF DESCRIPTION OF THE DRAWING

In the Drawings, which is by way of example, there is shown a low voltage hybrid system for a heavy duty vehicle:

FIG. 1 is a block diagram illustrating the low voltage hybrid system of the invention;

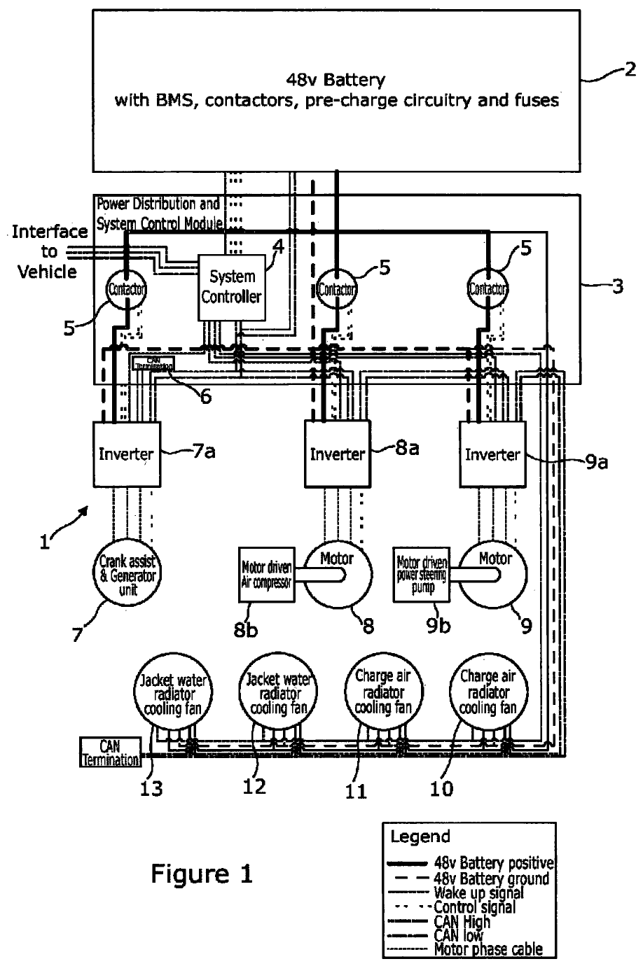

FIG. 2 illustrates a heavy duty vehicle equipped with a system according to the invention.

### DETAILED DESCRIPTION OF THE PREFERRED EMBODIMENTS

In the illustrated example, the low voltage system 1 comprises a 48 volt battery 2 which includes a battery management system, contactors, pre-charge circuitry and fuses. Connected to the battery 2 is a power distribution and system control module 3.

The power distribution and system control module 3 comprises a system controller 4 and a plurality of contactors 5, one for each inverter driven electrically powered device, and controlled area network (CAN) terminals 6.

In the illustrated example there are three inverter driven electrically powered devices that are connected to the power distribution and system control module 3 and four electrically powered devices that are connected directly to the power distribution and system control module 3. A crank assist generator unit 7 is driven via inverter 7a. A motor 8 which drives an air compressor 8b is driven by inverter 8a. A motor 9 which drives a power steering pump 9b is driven by inverter 9a. Cooling fans 10, 11 for cooling the charge air radiator and cooling fans 12, 13 for cooling the jacket water radiator are connected directly to the power distribution and system control module 3. The cooling fans have a smaller power requirement than the inverter driven components and hence do not require inverter control. The electrically powered devices described do not form an exhaustive list and are simply examples that may be found on a typical heavy duty vehicle. Inverter and non-inverter driven electrically powered devices may be added or removed according to the requirements of a particular vehicle.

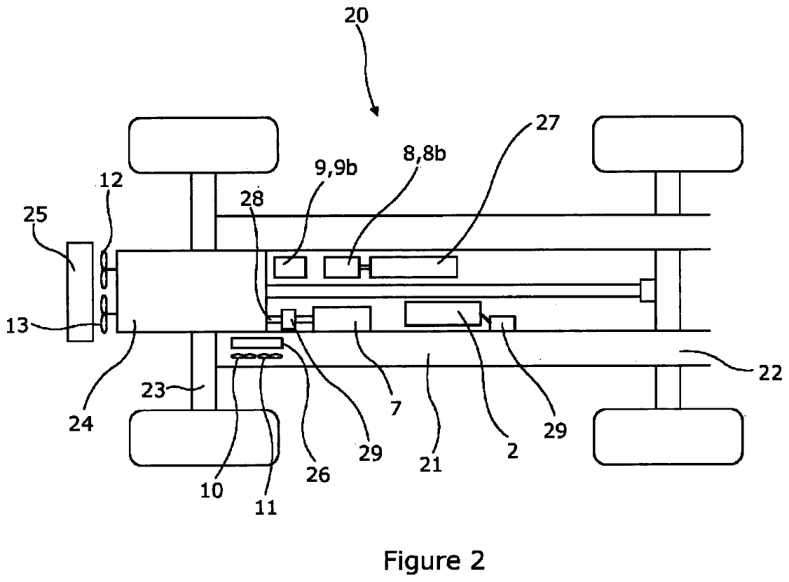

FIG. 2 illustrates a heavy duty vehicle 20 comprising a chassis 21 to which are mounted a rear axle 22, a front axle 23 and an internal combustion engine 24, typically a diesel engine. To the front of the engine 24 is a jacket water radiator 25 which is cooled by cooling fans 12, 13. To the side of the engine 24 is a charge air radiator 26 which is cooled by fans 10, 11. To the rear of the engine 24 is a power steering pump motor 9 which drives a power steering pump 9b, the two components represented by a single block in the figure.

The engine 24 has a power take off shaft 28. A crank assist and generator unit 7 is mounted to the chassis and is coupled to the power take off shaft 28 by means of coupling 29.

Also mounted on the chassis is an air tank 27 and the air compressor motor 8 which drives the air compressor 8b.

A battery 2 is mounted on the chassis with a charging connector 29 proximate thereto.

The actual position of the electrically powered components on the chassis is not essential. The need to locate motors directly adjacent the engine for rotational coupling therewith is avoided. The system of the invention allows components to be positioned in the ideal position for the component, with power to the electric motor for the component being delivered via wires. In heavy duty vehicles of the prior art it is necessary to position powered components proximate the engine so that they may be driven directly by the engine or via belts or chains. Electrification of the auxiliary components provides a significantly greater degree of design freedom. Of course, the crank assist and generator unit 7 must be connected to the engine. However, by connecting the unit 7 to the power take off shaft 28, rather than to the crank shaft of the engine, there is significantly more design freedom in positioning the unit 7. The unit 7 may be offset relative to the power take off shaft 28 and be driven by a belt, chain or gear set for example.

The air compressor of a heavy duty vehicle of the prior art places a significant demand on the vehicle's engine. Typically the air compressor is driven by a belt or chain extending around pulley wheels or cogs of the compressor and the engine. The vehicle's air tanks are filled with air until a maximum pressure is reached, at which point a valve is opened to release compressed air from the tank. When the vehicle is travelling along with no braking requirement the compressor supplies compressed air but there is no consumption of compressed air from the air tanks. The result is the periodic opening of the air release valve. This is very wasteful of energy. Furthermore, it is also a requirement that the air compressor must be able to pressurise the air tanks from empty within a certain period of time with the engine at idle. Since the compressor is powered directly by the engine the faster the engine rotates the more the compressor compresses the air.

The present invention, by powering the compressor with an electric motor, allows the size of the compressor to be reduced and the overall power consumption of the compressor over time to be reduced. The motor 8b can be operated at an optimum speed off battery power when the vehicle is at idle, thereby removing the relationship between engine speed and compressor speed. Also, when the pressure in the air tank 27 has reached an optimum level, which may be when the air tank 27 is not completely full, the motor 8b can be switched off. Hence, the compressor can be sized according to its optimum speed rather than the idles speed of the vehicle's engine and the compressor is only operated when there is a demand to pressurise the air tank 27. In experiments it has been found that the size of the air compressor may be reduced by in the region of 50% and to reduce the average consumption of power by a factor of sixteen.

In the present invention the air compressor motor 8, air compressor 8b and the air tank 27 form part of a regenerative braking system. A regenerative braking system functions by switching the crank assist and generator unit 7 to generator mode. When vehicle sensors indicate that the vehicle is coasting or braking the system controller 4 switches the crank assist and generator unit 7 in generator mode (this is described in greater detail below). The first priority is to recharge the battery 2. However, if the battery is already fully charged the electrical power generated by the unit 7 may be used to pressurise the air tank 27 above its optimum level.

Drivers of heavy duty vehicles are trained to control vehicle speed using engine braking. Some heavy duty vehicles are provided with an exhaust brake which increase the effect of engine braking. A low voltage hybrid system of the invention may be configured to provide a braking effect similar to that provided by an exhaust brake by causing the crank assist and generator unit to generate electricity.

A vehicle equipped with the low voltage hybrid system of the present invention may be provided with numerous sensors for sensing different parameters of the vehicle and its components. For example, sensors may be provided to detect engine load, vehicle speed, acceleration, battery charge level, coolant temperatures, air tank pressure, etc. The system controller 4 receives signals from the sensors over the CAN bus 6. The system controller 4 may also be connected to the engine and transmission via the CAN bus 6 in order that the system controller may monitor engine and transmission state and driver control inputs. The system controller then makes priority decisions based on the battery state of charge, the demand of ancillary components and the vehicle condition.

For example, after a period of rest the air tanks of a heavy duty vehicle will be depressurised and will require repressurisation within a certain period of time. In such a circumstance, when the vehicle is first started the system controller will receive a signal from the air tank pressure sensor indicating low pressure. The system controller is configured to operate the air compressor motor 8b, which causes the air compressor 8 to charge the air tank 27 to a predefined optimum level.

The system controller may be configured so that no power is drawn from the engine to generate electricity when the vehicle is accelerating, and depending on the type of crank assist and generation unit 7, the system controller 4 may be configured to draw power from the battery to deliver power to the vehicle.

The system controller may be configured to switch the crank assist and generator unit 7 to generate electricity when the vehicle is coasting or is being braked and to generate electricity at a rate that is proportional to the braking effort and/or vehicle speed. For example, if the vehicle is coasting (which may be detected by an accelerator position sensor) and the vehicle's speed is increasing then the operating the generator can be used to reduce the vehicle's acceleration.

In relation to power steering, the illustrated example shows an electro-hydraulic power system that is a power steering hydraulic pump 9b is powered by an electric motor 9. Alternatively the power steering may be electric where an electric motor is connected directly to the vehicle's steering rack. The system controller 4 may be configured so that the degree of assistance provided by the power steering system varies with vehicle speed, more assistance being provided at low speed, with less assistance at high speed. Furthermore, the system controller may be configured to cause the crank assist and generator unit 7 to generate electricity and charge the battery 2 when the battery charge is insufficient to operate the power steering.

Priorities may be ranked. For example, one priority mentioned above is to stop generating electricity when the vehicle is accelerating. However, if the system controller 4 detects that the battery charge level is insufficient to operate the power steering, the crank assist and generator unit 7 will nevertheless be caused to generate electricity to charge the battery 2 to the prescribed threshold for operation of the power steering.

A vehicle equipped with the low voltage hybrid system of the invention may be provided with a charging point 29 in order that the battery may be recharged from an external source.

The system controller may be configured to pre-condition the vehicle so that when the vehicle is required it is ready to use. For example, the system controller may be configured to heat windows and/or the cabin of the vehicle. Similarly, where the vehicle is provided with an engine block heater the system controller may cause the engine block heater to heat the engine block, for example to a desired temperature or for a desired period of time.

The low voltage hybrid system of the present invention provides for significantly reduced fuel consumption by heavy duty vehicles by reducing parasitic loads on the vehicle's engine, by harvesting energy that would be wasted and by utilising the pneumatic system of the heavy duty vehicle for energy storage.

1. A hybrid system for a heavy duty vehicle having an engine and a pneumatic system, the hybrid system comprising a direct current (dc) network, and connected to the dc network electrical components including: a battery, a starter/generator electric machine having a power delivery mode in which an electrical energy input to the starter/generator is converted into a rotational power output and an electricity generation mode in which a rotational power input is converted into an electrical power output, a plurality of electrically powered ancillary devices one of which is an electrically powered compressor of the pneumatic system, a plurality of vehicle parameter sensors, a communications network and a controller, wherein the controller, the vehicle parameter sensors and the electrical components are connected to the communications network; and wherein the controller is configured to control the flow of electricity between the starter/generator, the battery, and the electricity consuming devices according to pre-programmed priorities and wherein the priorities include causing kinetic energy converted into electrical energy by the starter/generator when in its electricity generation mode to be stored in one of the battery by charging the same and the pneumatic system by operating an electric motor driven air compressor of the pneumatic system, wherein the dc network has a peak voltage not exceeding 60 volts and wherein the pneumatic system comprises an air compressor and a compressed air tank and wherein the air compressor is powered by an electric motor and wherein the pneumatic system has an optimum air tank pressure, wherein during one of coasting and braking of a heavy duty vehicle equipped with the hybrid system, the common controller switches the starter/generator electric machine to its electricity generation mode and controls the flow of electricity to selected ones of the battery, the electric motor of the air compressor and electricity consuming devices according to pre-programmed priorities, wherein the air tank is specified such that it may be pressurised to a second pressure greater than the optimum air tank pressure, wherein the air tank is provided with a pressure sensor and the algorithm prioritises pressurising the air tank to one of the optimum pressure and the second pressure when the vehicle is one of coasting and braking and the battery is fully charged by operating the compressor to pressurise the air tank.

2. (canceled)

3. A hybrid system according to claim 2, wherein the pneumatic system includes pneumatically operated brakes.

4. (canceled)

5. (canceled)

6. A hybrid system according to claim 1, wherein under braking the generator subjects the engine to a load and that load is proportional to the braking effort.

7. A hybrid system according to claim 1, wherein the controller switches the starter/generator out of generation mode when the vehicle accelerates.

8. A hybrid system according to claim 1, wherein the electricity consuming devices include a power steering motor, and wherein the controller controls the speed of the power steering motor according to the speed of the vehicle, reducing the power steering motor speed with increasing vehicle speed.

9. A hybrid system according to claim 8, wherein the controller causes the starter/generator to charge the battery when the battery charge level is below a threshold charge level required to operate the power steering motor.

10. A hybrid system according to claim 1, wherein the plurality of electricity consuming devices includes one or more inverter driven devices.

11. A heavy duty vehicle including a hybrid system according to claim 1, wherein the engine includes a power take off shaft and wherein the stater/generator electric machine is driven by the power take off shaft.

12. A heavy duty vehicle according to claim 11, wherein the power take off shaft is coupled to the starter/generator electric machine by one of: a direct coupling, a gear set, a belt drive and a chain drive.

13. A heavy duty vehicle including a hybrid system according to claim 1, wherein the starter/generator is located between the engine and the transmission of the vehicle.

13. A hybrid system according to claim 1, wherein the electricity consuming devices include at least one cooling fan motor and wherein the algorithm priorities operation of the at least one cooling fan motor according to the cooling requirements of the vehicle.
